(19) United States
(12) Patent Application Publication
(10) Pub. No.: US 2010/0042565 A1
(43) Pub. Date: Feb. 18, 2010

(54) MEZZAZINE IN-DEPTH DATA ANALYSIS FACILITY

(75) Inventor: Moisey AKERMAN, Upton, MA (US)

Correspondence Address: STRATEGIC PATENTS P.C.., C/O PORTFOLIOIP, P.O. BOX 52050, MINNEAPOLIS, MN, 55402, US

(73) Assignee: Crossbeam Systems, Inc., Boxboro, MA (US)

(21) Appl. No.: 12/539,175

(22) Filed: Aug. 11, 2009

Related U.S. Application Data
(63) Continuation-in-part of application No. 11/926,292, filed on Oct. 29, 2007.
Application No. 11/926,292 is a continuation-in-part of application No. 11/610,296, filed on Dec. 13, 2006.
Application No. 11/610,296 is a continuation-in-part of application No. 11/174,181, filed on Jul. 1, 2005.
Application No. 11/174,181 is a continuation of application No. 09/840,945, filed on Apr. 24, 2001, now abandoned.
Application No. 11/610,296 is a continuation-in-part of application No. 11/173,923, filed on Jul. 1, 2005.
Application No. 11/173,923 is a continuation of application No. 09/790,434, filed on Feb. 21, 2001, now abandoned.
(60) Provisional application No. 61/087,781, filed on Aug. 11, 2008.
(60) Provisional application No. 60/235,281, filed on Sep. 25, 2000.
(60) Provisional application No. 60/235,281, filed on Sep. 25, 2000.

(51) Int. Cl. G06G 7/00; G06N 5/00

(52) U.S. Cl. 706/20

(57) ABSTRACT

A mezzanine adapter based data processing facility provides in-depth data analysis that is presented as a digest of advanced statistics and network measures including latency data, content analysis, bidirectional flow related characteristics, multiple flow related statistics over a count of connections or over a period of time, and the like.

### CROSS-REFERENCE TO RELATED APPLICATIONS

This application claims the benefit of the following commonly-owned U.S. Provisional Patent Application (PPA) Ser. No. 61/087,781, filed on Aug. 11, 2008, incorporated herein by reference in its entirety.

This application is a continuation-in-part, and claims the benefit, of each of the following commonly-owned U.S. patent applications, each of which is incorporated herein by reference in its entirety: Ser. No. 11/926,292, filed Oct. 29, 2007, which is a continuation in part of commonly-owned Ser. No. 11/610,296, filed Dec. 13, 2006. Ser. No. 11/926,292 claims the benefit of the following commonly-owned U.S. Provisional Patent Applications, each of which is incorporated herein by reference in its entirety: PPA No. 60/749,915, filed on Dec. 13, 2005; PPA No. 60/750,664, filed on Dec. 14, 2005; PPA No. 60/795,886, filed on Apr. 27, 2006; PPA No. 60/795,885, filed on Apr. 27, 2006; PPA No. 60/795,708, filed on Apr. 27, 2006; PPA No. 60/795,712, filed on Apr. 27, 2006; and PPA No. 60/795,707 filed Apr. 27, 2006. Ser. No. 11/610,296 is also a continuation-in-part of the following commonly-owned U.S. patent applications, each of which is incorporated herein by reference in its entirety: Ser. No. 11/174,181, filed Jul. 1, 2005, which is a continuation of commonly-owned Ser. No. 09/840,945, filed Apr. 24, 2001, which in turn claims priority to commonly-owned PPA No. 60/235,281, filed Sep. 25, 2000; and Ser. No. 11/173,923 filed on Jul. 1, 2005, which is a continuation of commonly-owned Ser. No. 09/790,434, filed Feb. 21, 2004, which in turn claims priority to commonly-owned U.S. PPA No. 60/235,281, filed Sep. 25, 2000.

This application is also related to the following commonly-owned U.S. patent applications, each of which is incorporated herein by reference in its entirety: Ser. No. 11/877,792, filed Oct. 24, 2007; Ser. No. 11/877,796, filed Oct. 24, 2007; Ser. No. 11/877,801, filed Oct. 24, 2007; Ser. No. 11/877,805, filed Oct. 24, 2007; Ser. No. 11/877,808, filed Oct. 24, 2007; Ser. No. 11/877,813, filed Oct. 24, 2007; Ser. No. 11/877,819, filed Oct. 24, 2007; Ser. No. 11/926,307, filed Oct. 29, 2007; and Ser. No. 11/926,311, filed Oct. 29, 2007.

### BACKGROUND

1. Field

The methods and systems herein generally pertain to network data analysis, and particularly to in-depth network data digest generation and presentment.

2. Description of the Related Art

In general, router/switch based network analysis techniques support network traffic management by detecting a flow (usually defined by a source-destination) and reporting basic counter based digests of these detected flows. Router/switch based solutions may include functionality added to the routers/switches in a distributed way to analyze the traffic and gather statistics and to establish a flow-based assessment of the traffic passing through the infrastructure. Although router/switch based solutions may be located at various sub-network intersections in a network, analyzing data on a link that handles a lower bandwidth of data (e.g. closer to a server or a data storage facility) may allow more processing of flows with a given amount of compute resources. The deeper analysis resulting from the additional processing provides an opportunity to have more visibility to the data. This is at least due in part to a switch or router based solution dealing with highly complex data flow multiplexing activity, so in-depth access to the data is quite difficult to achieve.

Although network behavior analysis and heuristic algorithms may be applied to network traffic digests to create network flow models or conclusions about network traffic, the desired result generally focuses on network performance factors. Therefore, data digests collected by and reported from router/switched based techniques are generally performance focused. Critical techniques for determining and improving service levels in IT infrastructures require different and more in-depth data to achieve success with service level management, business service management, datastore service management, virtualization service management, and the like.

### SUMMARY

Providing the in-depth network data analytics needed by next generation service management applications and systems requires a novel approach to data analysis and digest presentment. Blade-based architectures have been proven to provide performance, flexibility, interchangeability, on-demand capabilities, and cost-performance levels that make them a highly desirable configuration for IT infrastructure components. Blade-based architectures are applicable to data servers, routers, application servers, datastore facilities, network managers, and many other IT infrastructure needs. A key component that facilitates the utility, flexibility, and at least the diverse functionality of blade-based architectures is the mezzanine card that provides direct connection between a processing element and a network. The processing element may be any type of server, data processor, and the like. The network may be a corporate infrastructure network (intranet), a datastore (e.g. individual data storage device, disk farm, or the like), a wide area network, and the like.

Combining the versatility of blade-based architectures with the near universality of mezzanine card interconnections, a new approach to data flow analysis that can support the in-depth data demands of advanced service management functionality is possible. Such a combination provides a wide array of benefits including backward compatibility with existing blade-based installations, economical deployment, interchangeability, programmability to support specific data digest needs, and the like.

In an aspect of the invention, a method may include providing an in-depth data analysis facility; disposing the facility on a blade-based architecture mezzanine adapter; analyzing data passing through the mezzanine adapter with the analysis facility, providing a digest of the data; and presenting the digest for infrastructure service management. In the aspect, the mezzanine adapter provides a network interface for a blade of the blade-based architecture. In the method, analyzing data includes any of identifying latency between packets, identifying network idle time, identifying inter-packet latency variation, determining suitability of a data flow for voice over ip, providing a multiple flow digest, determining desirability of a destination, analyzing a replication of the data passing through the mezzanine adapter, and the like. Further in the method, desirability of a destination is based on one or more of a count of connections by the same source, a count of connections to the same destination and a count of connections with the same service name. In the method, presenting the digest includes streaming the digest over the network port to one or more recipients. Streaming the digest increases bandwidth requirements of the network port by less than 2 percent.

In another aspect of the invention, a system includes an in-depth data analysis facility disposed on a mezzanine adapter of a blade-based server, the in-depth data analysis facility for generating an infrastructure service management-based digest of data that passes through the mezzanine adapter. In the aspect, the in-depth data analysis facility further includes: a processing facility for analyzing data; data digest algorithms for execution by the processing facility; a memory for storing at least a digest of the data provided by the processing facility; a network port for connecting the processing facility to a business network; and a server port for connecting the processing facility to a server. Further in the aspect, the algorithms are accessible to the processing facility in the memory.

In yet another aspect of the invention, a business service management method may include providing an in-depth data analysis facility; disposing the facility on a blade-based architecture mezzanine adapter; analyzing customer service data passing through the mezzanine adapter with the analysis facility, providing a measure of the level of quality of customer service; and transmitting the measure to a server. In the aspect, the mezzanine adapter provides a network interface for a blade of the blade-based architecture. Further in the aspect, the measure of the level of quality includes analysis of one or more of latency between packets, network idle time, inter-packet latency variation, and multiple flows. Transmitting the measure includes streaming data representing an aspect of the measure over the network port to one or more recipients. In the aspect, analyzing customer service data includes analyzing a replication of the data passing through the mezzanine adapter.

These and other systems, methods, objects, features, and advantages of the present invention will be apparent to those skilled in the art from the following detailed description of the preferred embodiment and the drawings. Each document mentioned herein is hereby incorporated in its entirety by reference.

### BRIEF DESCRIPTION OF THE FIGURES

The invention and the following detailed description of certain embodiments thereof may be understood by reference to the following figures:

FIG. 1 depicts elements of one or more mezzanine data analysis facilities.

FIG. 2 depicts a plan view of a blade-based embodiment of the mezzanine data analysis facility.

FIG. 3 depicts a network-based data flow analysis embodiment.

FIG. 4 depicts a data storage-based data analysis embodiment.

### DETAILED DESCRIPTION

A mezzanine approach for in-depth data analysis and characteristic digest presentment may be applicable for a general market of blade-based architectures. A mezzanine-based approach to in-depth data assessment has advantages over remote network traffic measurement techniques because the traffic bandwidth demand through a mezzanine card allows an economical implementation, such as using programmable processing facilities to extract more in-depth information. A data switch handles bandwidth of up to 100× that of a mezzanine card. The mezzanine card lower data bandwidth requirement may facilitate performing more in-depth data analysis resulting in more valuable network/data characteristic digest information. In an example, a network switch may deal with 100× data bandwidth, while a network application gateway may deal with 10× data, yet the data bandwidth through a mezzanine card to a variety of servers is only 1×. Therefore, overall performance is not substantially affected even though the data is more deeply analyzed by the system.

While remote (router/switch based) solutions may collect data that is somewhat rudimentary, such as counter based data (e.g. #packets, #bytes), the mezzanine data flow analyzer can identify very specific characteristics of the traffic flow by extracting (for example) latency between packets, analyzing the content of the packets, and an endless number of other characteristics, a few of which may include bidirectional flow related characteristics, multiple flow related statistics over a count of connections or over a period of time, and the like.

Bidirectional flow related characteristics may include delay variation in packets flowing from client-to-server, delay variation in packets flowing from server-to-client, size of client questions, size of server answers, client-to-server idle time, server-to-client idle time, combinations and calculations of the above including average, mean, sigma, and the like. In an example of delay variation in packets flowing from client-to-server, inter-packet time may be measured for each packet so that a series of values representing the time between packets may be collected. Analysis of this data may result in a determination of measures of a variation of inter-packet time, which may represent packet jitter or inter-packet latency variation. Jitter, such as average jitter, mean jitter, jitter sigma and the like may be important in a determination of a given link performance, quality, and the like. High jitter (large inter-packet latency variation) may indicate a poor quality of service that may indicate the link, which may include network devices throughout the link, may not be suitable for services that require low jitter. An example of a service that is jitter-sensitive is voice over IP.

Multiple flow related statistics observed over a number of connections may include a count of connections made by the same source, a count of connections made to the same destination, a count of connections with the same service made by the same source, a count of connections with the same service made to the same destination, and the like. Source and destination connection counting may demonstrate relative talkativeness of a source or desirability of a destination. In a security example, observing many attempts by a single source IP address to connect each one being a separate flow over a number of connections may indicate a potential intrusion threat. It may alternatively be used to determine a behavior model for the source IP that may later be used with heuristic network model analysis to determine when the source IP appears to be exhibiting abnormal network behavior.

Multiple flow related statistics observed over a period of time may include size of client questions during the last time window, size of server answers during the last time window, client-to-server idle time during the last time window, server-to-client idle time during the last time window, a count of connections made by the same source during the last time window, a count of connections made to the same destination during the last time window, a count of connections with the same service made by the same source during the last time window, a count of connections with the same service made to the same destination during the last time window, and the like. Additionally, statistics observed from several flows over a defined period of time may facilitate security applications, such as to validate proper execution of a security application that scans for improperly opened ports.

In an example of a business service management application of the above specific deep analysis network statistics gathering of the mezzanine card, ecommerce web service providers may want to make sure that responsiveness of a web service meets a required level of quality regardless of the number of user connections requested. Other applications may include real time services (e.g. securities trading), multimedia or mixed media services (e.g. pay for quality of service), and the like.

Another benefit of a mezzanine card based in-depth data analysis solution is that it can be additive to any existing solution. Current data analysis and digest functionality may be combined with or used in association with mezzanine in-depth analysis to provide a wide range of data characteristic collection. In this way, comprehensive data extraction can be split among the switch, gateway, mezzanine card, server, and other techniques. Providing an additive solution allows an IT manager or planner to get the most out of an existing infrastructure instead of requiring the wholesale replacement of components.

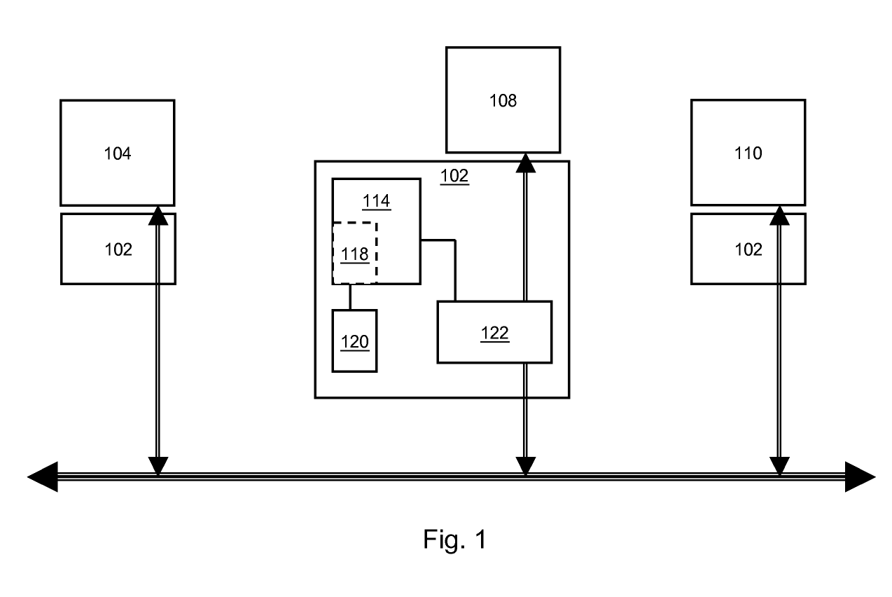

Referring to FIG. 1 that depicts elements of one or more mezzanine data analysis facilities, a mezzanine data analysis facility 102 may be configured with a data host 104, a virtual machine server 108, an application server 110, or other network infrastructure components, such as a network 112. As is depicted in FIG. 1, the flexibility of the mezzanine data analysis facility 102 facilitates its use with a wide variety of server architectures, performance levels, and capabilities. The mezzanine data analysis facility 102 may include one or more processing facilities 114 that may execute algorithms 118, memory 120, and a network port 122. The processing facilities 114 may include a commercial-off-the-shelf (COTS) processor. The algorithms 118 may be compiled to a native format compatible with the COTS processor, and the compiled algorithms may be stored in the memory 120 that is accessible by the processing facilities 114. Alternatively, the processing facilities 114 may be a special purpose processor and the algorithms 118 may be configured in hardware elements of the processing facilities 114. The special purpose processor may be an application accelerator, an application specific integrated circuit, a field programmable gate array, data flow processor, and the like. The memory 120 may store the algorithms in an uncompiled, compiled, or generic format. The memory 120 may also store information associated with an analysis of the data that is visible on the network port 122. The memory 120 may include analysis results, network port data characteristics, instructions for compiling and/or executing the algorithms, information to facilitate the presentment of the in-depth data analysis digest (e.g. a network device address to receive the data digests), and the like. The network port 122 may include processing capabilities to facilitate full operation of the network port 122 including capabilities to replicate data 124 presented on the network port without disturbing the flow of network data 128 through the mezzanine card to the server, etc. The replicated data 124 may be provided to the processing facilities 114 for in-depth analysis based on the algorithms 118 being executed.

The algorithms 118 may be configured to enable deep analysis of the replicated data 124. In addition to basic analysis and record keeping such as SNMP indices, time stamps, number of bytes, layer 3 headers, TCP flow flags, layer 3 routing information, and the like, the algorithms 118 may facilitate determining latency data, analyzing content, digesting bidirectional flow related characteristics, digesting multiple flow related statistics over a count of connections or over a period of time, and the like.

As the data is analyzed and a digest is generated, a mezzanine analysis facility 102 may stream the digest of information to recipients such as on a subscription or streaming basis. Although the data collection and analysis may be very deep, the resulting digestion output may only contribute 1% to network bandwidth demand. Therefore a more in-depth data and network traffic analysis can be efficiently deployed without significantly increasing network bandwidth requirements of the IT infrastructure.

In an embodiment, the mezzanine data analysis facility 102 may become another node (computer) connected to the network or data storage facility. In this way, other network nodes, such as a control computer or IT client, can interact with the facility 102 to provide updates, resolve conflicts, diagnose, and configure the facility 102.

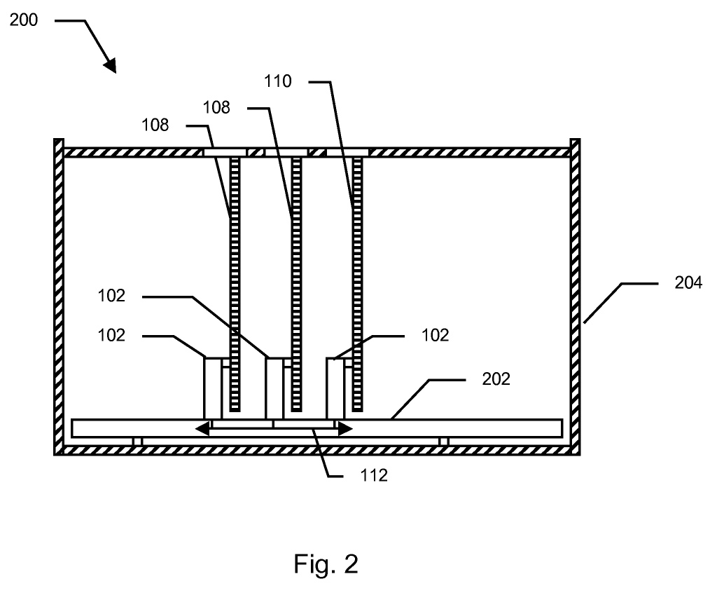

Referring to FIG. 2 in which a portion of a multi-blade based system configuration 200 includes the mezzanine card being used for a network interface, a chassis 204 may support a backplane 202 interconnected to a plurality of blade computing facilities through one or more mezzanine data analysis facilities 102. The system configuration 200 may include one or more virtual machine servers 108 communicating over a network 112 to one or more application servers 110, and the like. Each server may be interconnected to a network 112 portion of the backplane 202 through a mezzanine analysis facility 102. The mezzanine analysis facility 102 may be configured uniquely for each server to provide support for data analysis and/or data flow processing of data being transmitted to/from the blade over the network.

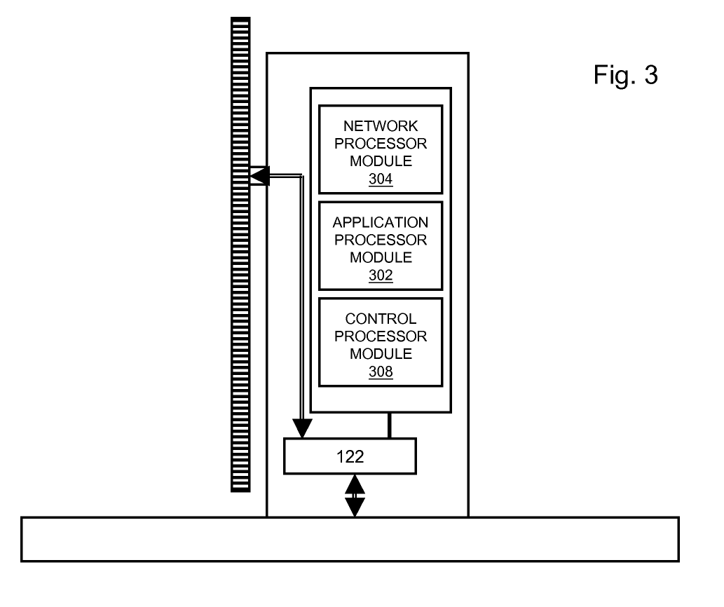

Referring to FIG. 3, an embodiment of an application server configuration 300 may include an application server 110 connected to a network 112 through a mezzanine analysis facility 102 that include processing facilities 114. To provide data flow processing and application serving capabilities, the computing facilities 114 may include one or more of an application processor 302, a network processor 304, and a control processor 308. Network interface port 122 may include functionality to switch data flows from the network 112 to the application server 110, to the processing facility 114, or to both. The network port 122 may be configured as a switching fabric to facilitate switching data flows. Data routed from the network 112 to the processing facilities 114 may be processed and then forwarded to the application server 110 through the network port 122. Likewise, data destined for the network 112 from the application server 110 may be directed through the network processor module 304 or the application processor module 302 by the network port 122 prior to being forwarded to the network 112.

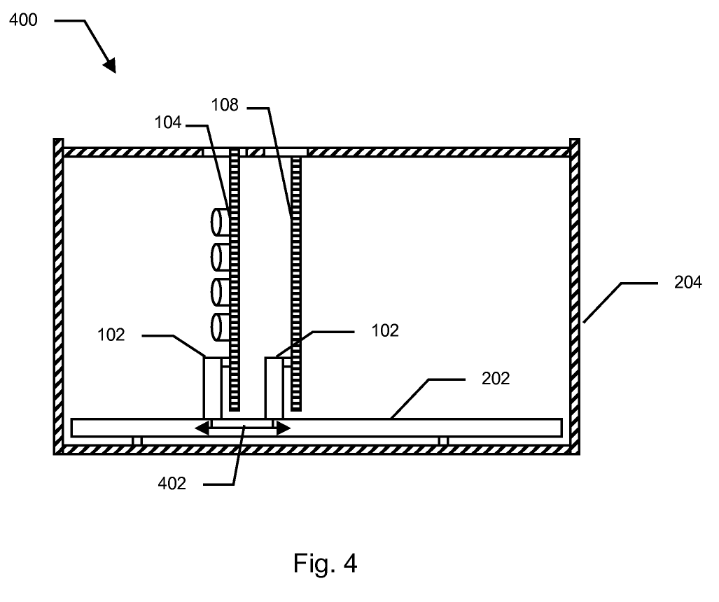

Referring to FIG. 4, which depicts a system configuration 400 in which one mezzanine data flow processor 102 is configured to provide access by a plurality of servers to a data storage facility 104 over a data storage channel 402 and a second data flow processor 102 is configured to analyze data exchanged between a server 108 and the data storage channel 402. The mezzanine data analyzer 102 that provides interconnection to the storage facility 104 may provide data analytics and digest information for access by a plurality of servers to improve data storage facility 104 performance, cost, availability, and the like. The mezzanine data analyzer 102 that interfaces the server 108 to the data channel 402 may perform in-depth analysis of storage channel 402 data that is accessed by the server 108. Many other system configurations, mezzanine data analysis features, data flow processing capabilities, and the like are contemplated and included herein. In an example, a single server may be connected to a backplane through a plurality of mezzanine adapters for different purposes, such as network data interfacing, data channel interfacing, and the like.

The growing markets of service level management (SLM), business service management (BSM), data service management (DSM), and the like provide information and capabilities to measure and adjust network performance to meet preferred service or business service objectives. These systems rely on a deep understanding of the fundamental aspects of an IT infrastructure and data flow so that the infrastructure can be properly configured, aligned, or utilized to meet the service, business, and data objectives. While aspects of network performance such as events (logins, failed logins, etc) and applications (email, data services, etc) can be monitored and reported, attaining an in-depth understanding of the network, its performance, its content, and the like is critical to achieving excellence in SLM, BSM, DSM, and the like.

Service-level management (SLM) includes monitoring and management of the quality of service (QoS) of an entity's key performance indicators (KPIs). The key performance indicators may range from coarse-grained availability and usage statistics to fine-grained entity-contained per-interaction indicators, and the like. The mezzanine data analysis facility 102 may provide the capabilities needed to collect up relevant, real-time data that enables accurate measurement of KPIs.

Business-service management (BSM) may include a strategy and an approach for linking key IT components to the goals of the business. It facilitates understanding and predicting how technology impacts the business and how business impacts the IT infrastructure. Business service requires an ability to link IT performance and features to business, such as through transactions. The mezzanine data analysis facility 102 enables an in-depth analysis of network data to identify business specific information and provide measurement and feedback on how the IT infrastructure is enabling or hindering business service fulfillment. In an example, while transactions per unit time may be a measure of business service fulfillment, understanding how the content of the transactions (the content of the network data) impacts the IT infrastructure requires an ability to deeply analyze network transactions rather than merely count them.

Service management for virtualized networking, such as data centers, servers, applications, and other information technology business infrastructure resources may require self learning capabilities that learn and adapt to constant changes of these virtual machine-type environments. Modeling of these infrastructure elements and systems facilitates improving virtual-machine type service. However, data that supports behavior analysis and self-learning of performance related system capabilities is essential to enable proper modeling of user interactions and the impact and behavior of these virtual machine type resources and applications in real-time. The characteristics of network flows, server flows, data center flows, and the like that are determined from digest data provided by the mezzanine data flow analysis facility 102 may provide the data needed for virtual machine service management. Because the mezzanine data flow analysis facility 102 is disposed throughout the business infrastructure, it may provide in-depth digests of data characteristics for many points in the infrastructure throughout a business lifetime. In this way, data virtualization, machine virtualization, application virtualization, user interactions and the like can be analyzed, digested, and presented for activities such as automated virtual resource event accounting and service management.

Additionally, a new trend in the market is a merging of network switching and data storage. Having digests from both network and storage flow in the system allows one to make combined decisions. Because the mezzanine data analysis facility 102 footprint links compute blades to the network or to a storage infrastructure, the data analysis functionality provided by the facility 102 can be beneficially applied to data transactions, management, allocation, and the like.

A mezzanine data flow analysis facility may be associated with data flow processing. The mezzanine data flow analysis facility may include a data flow processing facility as described in U.S. patent application Ser. Nos. 11/926,292 and 11/173,923, both of which are incorporated herein by reference in their entireties.

A mezzanine data flow analysis facility may be associated with content search. The mezzanine data flow analysis facility may facilitate content search by performing content search based on an Aho-Corasick algorithm; performing anomalous flow detection; performing behavioral analysis; reducing false-positive detections; handling multiple-flows; facilitating training of a neural network embodiment; and the like. The mezzanine data flow analysis facility may include implementation in dedicated hardware, in a general-purpose computer; using a neural network, using artificial neurons, and the like.

A mezzanine data flow analysis facility may be associated with content matching. The mezzanine data flow analysis facility may facilitate content matching through the use of a matching engine incorporated in to the facility. The mezzanine matching engine may include action rules based on match results and may include Aho-Corasick optimization, hardware, position-related patterns, regular expressions and the like. The action rules may include failure-to-match handling. The mezzanine matching engine may include discontinuous TCP packets, memory optimization, and on-chip implementation.

A mezzanine data flow analysis facility may be associated with neural structures for finding anomalous flows. The mezzanine data flow analysis facility neural structures may include artificial neurons, self-organizing maps, off-line or on-line training of normal communication flows including flows associated with applications (e.g. HTTP, SMTP, and the like) and flow payload (e.g. text, JPEG, and the like).

A mezzanine data flow analysis facility may be associated with communication flows. The mezzanine data flow analysis facility may facilitate processing communication flows such as IP data streams by inspecting headers, analyzing flows divided into chunks such as packets, performing normalization which may be expressed by standard deviations and the like.

A mezzanine data flow analysis facility may be associated with distance measurement. The mezzanine data flow analysis facility may facilitate distance measurement by employing high-speed circuitry, indirect addressing, and the like.

A mezzanine data flow analysis facility may be associated with processing position constraints in string searches. The mezzanine data flow analysis facility may facilitate position constrained string searches by detecting position dependent patterns, (e.g. within a specified position in a packet), absolute position patterns (e.g. measured from beginning of packet), negative and positive patterns, and the like. The position constraints may be expressed using the SNORT language.

A mezzanine data flow analysis facility may be associated with regular expression matching. The mezzanine data flow analysis facility may facilitate regular expression matching including any of matching characters, quantifiers, character classes, meta characters, greedy or non-greedy matching, look-ahead or look-behind matching, back-referencing, searching for position dependent substrings; matching by character class detector. Regular expression matching may operate within the mezzanine data flow analysis facility and include an algorithm for matching beginning of string, an algorithm for matching end of string, matching alternation, space-time tradeoff, matching repetitive patterns, and the like. Regular expression matching may be provided by the mezzanine data flow analysis facility as a hardware-based function.

A mezzanine data flow analysis facility may be associated with rules matching. The mezzanine data flow analysis facility may facilitate rules matching through action rules that may include header-based rules, content-based rules, and the like. Header-based rules may include compact representations of matched header rules such as a focused header rule and a promiscuous header rule.

A mezzanine data flow analysis facility may be associated with reassembly of TCP packets into a data stream. The mezzanine data flow analysis facility may facilitate packet reassembly by taking action on packets such as passing or dropping packets, receiving, modifying, and sending for content insertion, receiving, processing and returning for proxying or caching, trigger transaction and protocol translation, and the like.

A mezzanine data flow analysis facility may be associated with subscriber profiles. The mezzanine data flow analysis facility may facilitate supporting subscriber profiles that are stored, distributed, modified, associated with applications, and the like.

A mezzanine data flow analysis facility may be associated with a switch architecture. The mezzanine data flow analysis facility may include any of a Network Processor Module, a Flow Processor Module, a Control Processor Module, a Management Server, multiple processor modules, an open architecture, applications/services that are distributed to and throughout the processors, and the like.

A mezzanine data flow analysis facility may be associated with system architecture. The mezzanine data flow analysis facility system architecture may include serialization, parallelization, hot-swappable blades, wizard-based software installation and configuration, SNMP, secure SSH/SSL and HTTPS access to management interfaces, full audit trail, applications managed using their native management tools and the like.

A mezzanine data flow analysis facility may be associated with data flow management. The mezzanine data flow analysis facility may facilitate data flow management by supporting group software maintenance and scheduling; pre-configured device parameters (e.g. templates), configuration; back-up and restore; job scheduling; tiered, role-based administration, and the like.

A mezzanine data flow analysis facility may be associated with cryptography. The mezzanine data flow analysis facility may facilitate cryptography by supporting cryptographic signing and/or cryptographic encapsulation of transmitted data.

A mezzanine data flow analysis facility may be associated with content scanning. The mezzanine data flow analysis facility may facilitate content scanning by providing anti-virus capabilities, anti-spam features, anti-spyware functionality, pop-up blocker; malicious code protection, anti-worm and anti-phishing capabilities; exploit protection and the like.

A mezzanine data flow analysis facility may be associated with virtual network security. The mezzanine data flow analysis facility may facilitate virtual network security by establishing security policies for a plurality of virtual networks and processing data flows associated with the virtual networks based on the security policies associated with each virtual network.

A mezzanine data flow analysis facility may be associated with intrusion detection and prevention. The mezzanine data flow analysis facility may facilitate intrusion detection and prevention by detecting network security violations and preventing a violating data flow from propagating the security violations beyond the mezzanine data flow analysis facility. Detecting network security violations may include one or more of packet header inspection, packet payload inspection, content inspection, data stream behavioral anomaly detection, content matching, regular expressing matching, self-organizing maps, misuse algorithms, network protocol analysis, and neural networks.

A mezzanine data flow analysis facility may relate to and/or be directed at and/or associated with one or more of the following network applications: firewall; intrusion detection system (IDS); intrusion protection system (IPS); application-level content inspection; network behavioral analysis (NBA); network behavioral anomaly detection (NBAD); extrusion detection and prevention (EDP); any and all combinations of the foregoing; and so forth. Additionally or alternatively, the mezzanine data flow analysis facility may provide and/or be associated with a security event information management system (SEIM), a network management system (NMS), both a SEIM and a NMS, and so on. The network applications may exist and/or be associated with a network computing environment, which may encompass one or more computers (such as and without limitation the server computing facilities) that are operatively coupled themselves and/or to one or more other computers via a data communication system. Many data communications systems will be appreciated, such as an internetwork, a LAN, a WAN, a MAN, a VLAN, and so on. In embodiments, the communications system may comprise a flow processing facility. The mezzanine data flow analysis facility, an object of the present invention, may provide, enable, or be associated with any and all of the aforementioned network applications. Additionally or alternatively, the mezzanine data flow analysis facility may provide, enable, or be associated with numerous other functions, features, systems, methods, and the like that may be described herein and elsewhere.

A mezzanine data flow analysis facility may be associated with protocol analysis. The mezzanine data flow analysis facility may facilitate protocol analysis by performing packet arrival time stamping, packet filtering, packet triggering, and the like. In an example and without limitation, a network configuration of the mezzanine data flow analysis facility for very high speed networks like Gigabit Ethernet may include packet arrival time stamping to facilitate merging two or more data flows together for detection and prevention. This may facilitate detecting intrusions that do not sufficiently impact one flow to trigger an intrusion.

A mezzanine data flow analysis facility may be associated with machine learning logic. The mezzanine data flow analysis facility may support machine learning logic by continuously learning network traffic patterns of data flows such that a prediction may be made as to how much traffic is expected the next moment. In an example and without limitation, applying a rate based intrusion detection and prevention technique may facilitate predicting how many packets in all, how many IP packets, how many ARP packets, how many new connections/second, how many packets/connection, how many packets to a specific tcp/udp port, and so forth. Detection may activate intrusion prevention when a measured network traffic parameter is different than that predicted.

A mezzanine data flow analysis facility may be associated with data flow scheduling. The mezzanine data flow analysis facility may facilitate data flow scheduling by analyzing data passing through the mezzanine data flow analysis facility to determine if at least one processor associated with a blade to which the mezzanine adapter is connected has been identified for processing data and transferring a request for processing the flow to the at least one processor. Alternatively, the mezzanine data flow analysis facility may receive a request from the network for processing a data flow and determine if at least one of the processors on the supporting blade is identified for the processing by consulting a flow schedule stored in a memory of the mezzanine adapter. If at least one of the processors on the supporting blade is identified in the flow schedule, the mezzanine data analysis facility may prepare the data for processing by adding or removing header or other identifying information. The identifying information may facilitate collecting the processed data from the at least one processor and routing it over the network to a destination.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code, and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be a frequency division multiple access (FDMA) network or a code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software, or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
providing an in-depth data analysis facility;
disposing the facility on a blade-based architecture mezzanine adapter;
analyzing data passing through the mezzanine adapter with the analysis facility, providing a digest of the data; and
presenting the digest for infrastructure service management.

2. The method of claim 1, wherein the mezzanine adapter provides a network interface for a blade of the blade-based architecture.

3. The method of claim 1, wherein analyzing data includes identifying latency between packets.

4. The method of claim 1, wherein analyzing data includes identifying network idle time.

5. The method of claim 1, wherein analyzing data includes identifying inter-packet latency variation.

6. The method of claim 1, wherein analyzing data includes determining suitability of a data flow for voice over ip.

7. The method of claim 1, wherein analyzing data includes providing a multiple flow digest.

8. The method of claim 1, wherein analyzing data includes determining desirability of a destination.

9. The method of claim 8, wherein desirability of a destination is based on one or more of a count of connections by the same source, a count of connections to the same destination and a count of connections with the same service name.

10. The method of claim 1, wherein presenting the digest includes streaming the digest over the network port to one or more recipients.

11. The method of claim 10, wherein streaming the digest increases bandwidth requirements of the network port by less than 2 percent.

12. The method of claim 1, wherein analyzing data includes analyzing a replication of the data passing through the mezzanine adapter.

13. A system comprising:
an in-depth data analysis facility disposed on a mezzanine adapter of a blade-based server, the in-depth data analysis facility for generating an infrastructure service management-based digest of data that passes through the mezzanine adapter.

14. The system of claim 13, wherein the in-depth data analysis facility further includes:
a processing facility for analyzing data;
data digest algorithms for execution by the processing facility;
a memory for storing at least a digest of the data provided by the processing facility;
a network port for connecting the processing facility to a business network; and
a server port for connecting the processing facility to a server.

15. The system of claim 14, wherein the algorithms are accessible to the processing facility in the memory.

16. A business service management method comprising:
providing an in-depth data analysis facility;
disposing the facility on a blade-based architecture mezzanine adapter;
analyzing customer service data passing through the mezzanine adapter with the analysis facility, providing a measure of the level of quality of customer service; and
transmitting the measure to a server.

17. The method of claim 16, wherein the mezzanine adapter provides a network interface for a blade of the blade-based architecture.

18. The method of claim 16, wherein the measure of the level of quality includes analysis of one or more of latency between packets, network idle time, inter-packet latency variation and multiple flows.

19. The method of claim 16, wherein transmitting the measure includes streaming data representing an aspect of the measure over the network port to one or more recipients.

20. The method of claim 16, wherein analyzing customer service data includes analyzing a replication of the data passing through the mezzanine adapter.
